(19) United States
(12) Patent Application Publication
(10) Pub. No.: US 2007/0050448 A1
(43) Pub. Date: Mar. 1, 2007

(54) Method and system for information collaboration over an IP network via handheld wireless communication devices

(75) Inventors: Edward Gonen, Yoqneam Illit (IL); Shai Toren, Moshav Alonei Aba (IL); Boris Rakhlin, Haifa (IL)

Correspondence Address: WONG, CABELLO, LUTSCH, RUTHERFORD & BRUCCULERI,;L.L.P., 20333 SH 249, SUITE 600, HOUSTON, TX, 77070, US

(73) Assignee: Polycom, Inc., Pleasanton, CA (US)

(21) Appl. No.: 11/212,046

(22) Filed: Aug. 25, 2005

(51) Int. Cl. G06F 15/16

(52) U.S. Cl. 709/204

(57) ABSTRACT

The present invention provides methods and systems for establishing and conducting multimedia multipoint conference using one or more handheld wireless communication devices (HWCDs). In one embodiment, upon receiving a request from a HWCD user to establish or join a multimedia conference, a collaboration server responds by sending an appropriate web-client to the requester's handheld device. The multimedia conference may include data collaboration, with or without audio or video. During data collaboration, conference participants working on a shared file may send commands to the collaboration server, which then updates the file and sends the modified file to the conference participants.

### FIELD OF THE INVENTION

The present invention relates to the field of multimedia multipoint conferencing. More particularly, the present invention provides methods and systems for establishing and controlling multimedia communication session between two or more endpoints that include handheld wireless communication devices.

### BACKGROUND

Multimedia conferencing systems are increasing in popularity. These systems allow two or more individuals in different locations to collaborate and work together. Usually a multimedia multipoint conferencing system includes multimedia endpoints and a multipoint control unit (MCU). A multimedia endpoint is a terminal on a network that is capable of providing real-time, two-way communication with other terminals via the MCU. An endpoint may provide speech only, speech and video, speech, data and video communication or any combination thereof.

A multipoint control unit (MCU) is a conference controlling entity that is typically located in a node of a network or in a terminal. A MCU receives several media channels from access ports, processes audiovisual and data signals and distributes them to connected channels according to certain criteria. Examples of MCUs include MGC-100™, which is available from Polycom Inc. A more thorough definition of endpoint (terminal) and multipoint control unit can be found in the International Telecommunication Union (“ITU”) standards such as H.320, H.324, H.323, etc.

Different systems can be used to perform data collaboration or conferencing. For example, Symantec's pcAnywhere™ and Microsoft's NetMeeting™ allow PC users to collaborate over a shared software application or file. Furthermore, web collaboration conferencing is also available, allowing application and content collaboration to be performed over standard web protocols and Internet connections. Examples of data collaboration system include Polycom Web Office™, which is available from Polycom Inc. More information on Polycom WebOffice™ collaboration system can be found in U.S. patent application Ser. No. 10/941,790, the contents of which is incorporated herein by reference.

Concurrent with the increasing popularity of conferencing systems, it has become more popular for people to use handheld wireless communication devices while they are away from their offices. These devices can participate in data communication session using Internet Protocol (IP). Some of these handheld devices may have audio or audio/video capabilities that enable participation in a multimedia session. However, due to their limited computing power, these devices usually cannot participate in a data collaboration session.

Currently several methods are available for sharing information among peers using communication devices with limited computing power. In one method, a user can select information, incorporate that information into an email or instantaneous message, and send that email or instantaneous message to one or more recipients who must then read the content and manually transfer the information into appropriate applications on their own mobile communications device.

U.S. patent application Ser. No. 09/746,606 discloses another method wherein information sharing is carried out by a transferring server that allows a user to select certain data files and define one or more peers to receive the data. The transferring server then transfers the files to the defined peers. Information transfer can be done automatically or after receiving permission from the receiver. The transferred information is placed inside applications of the receiving mobile communication devices. However, the above method is limited only to transferring information; users of this system cannot collaborate and work simultaneously to manipulate the transferred information.

A method for data collaboration using personal data assistants (PDAs) is disclosed in U.S. patent application Ser. No. 10/288,005. This collaboration method requires client software to be installed in each PDA, and uses one of the participant's PDA to host the collaboration session. Therefore, performance of the collaboration session depends on the computing power and communication capabilities of the hosting PDA.

None of the above methods offers a solution for starting or joining a data collaboration session using a browser application in a common handheld wireless communication devices without prior modification of the device (e.g., pre-installation of a client application program). No method teaches conducting a data collaboration session over a web server among users of handheld wireless communication devices, wherein participants in the data collaboration session can manipulated the file that is being shared. In addition, none of the currently available methods offers a solution for starting or joining a data collaboration session which is part of a multimedia conferencing session.

Therefore, there is a need for an improved data conferencing method (with or without multimedia conferencing) for users of handheld wireless communication devices.

### SUMMARY OF THE DISCLOSURE

The present invention provides new methods of using handheld wireless communication devices to establish and conduct multimedia multipoint conferences. Communication session can be established between a plurality of handheld wireless communication devices, or between a handheld wireless communication device and a regular multimedia endpoint (MMEP). The communication session may include data collaboration, with or without audio or video. Representative handheld wireless communication devices include, but are not limited to, cellular phones and personal data assistants (PDAs). As used herein, the terms “handheld wireless communication devices” and “handheld devices” are used interchangeably. In general, these handheld devices have limited computing power as compared to computers such as personal computers or laptop computers, etc.

In one embodiment of the present invention, a collaboration server (CS) is used. The CS may respond to a request from a user of a handheld device to establish or join a multimedia session by sending an appropriate web-client (WC) to be used by a browser application that is installed in the requester's handheld device. The appropriate web-client can be a signed application or an unsigned application. The web client may be adapted to work in various operating systems such as Microsoft's Window Mobile™ operating system or Palm OS™ operating system, etc.

Using the web-client and the collaboration server, a requester may select appropriate participants, define the time of the conference or join an existing conference. An exemplary collaboration server may be an IP server (a server connected to an IP network) that is modified to work with the web-client. An example of IP server is disclosed in U.S. patent application Ser. No. 10/941,790, the content of which is incorporated herein by reference.

During the multimedia session established herein, a web-client is used by a user of a handheld device to work on shared data, i.e. a data file currently displayed to the participants of the data collaboration session. For example, the file can be a spreadsheet file and the current data can be a table; or the file can be a presentation file while the current data is one of the slides. Other types of data that can be shared by the users include snap-shot data, etc. The users manipulate the data by using the web-client, which then transfers the performed operation as commands to the collaboration server. The collaboration server may perform the changes on the file itself and create an updated image, which is distributed to the participants of the collaboration session. Distribution of the updated image may be done via a refresh command performed by the users. Alternatively, an automatic pulling process may be used. The automatic pulling process, which can be embedded in the web-client, may send a refresh request every few seconds, for example. Upon receiving a refresh command, the collaboration server may respond by sending the entire updated file or just the changes performed since the last refresh command.

The foregoing summary is not intended to summarize each potential embodiment or every aspect of the present disclosure, and other features and advantages of the present invention will become apparent upon reading the following detailed description of the embodiments with the accompanying drawings and appended claims.

Furthermore, although specific exemplary embodiments are described in detail to illustrate the inventive concepts to a person skilled in the art, such embodiments are susceptible to various modifications and alternative forms. Accordingly, the figures and written description are not intended to limit the scope of the inventive concepts in any manner.

### BRIEF DESCRIPTION OF THE DRAWINGS

Exemplary embodiments of the present invention will be more readily understood from reading the following description and by reference to the accompanying drawings, in which:

FIG. 1 is a simplified block diagram illustrating the relevant elements of a multimedia multipoint conferencing system.

FIG. 2 is a simplified block diagram illustrating the relevant modules of a handheld wireless communication device (HWCD) operative according to an exemplary embodiment of the present invention.

FIG. 3 is a simplified block diagram illustrating the relevant elements of a collaboration server (CS) operative according to an exemplary embodiment of the present invention.

FIG. 4a is a flowchart showing the relevant steps in an exemplary method of establishing a conference using a handheld wireless communication device.

FIG. 4b is a flowchart showing the relevant steps in an exemplary method of establishing a conference using a collaboration server.

FIG. 5 illustrates a flowchart showing the relevant steps in an exemplary process of working on shared information.

### DETAILED DESCRIPTION OF THE INVENTION

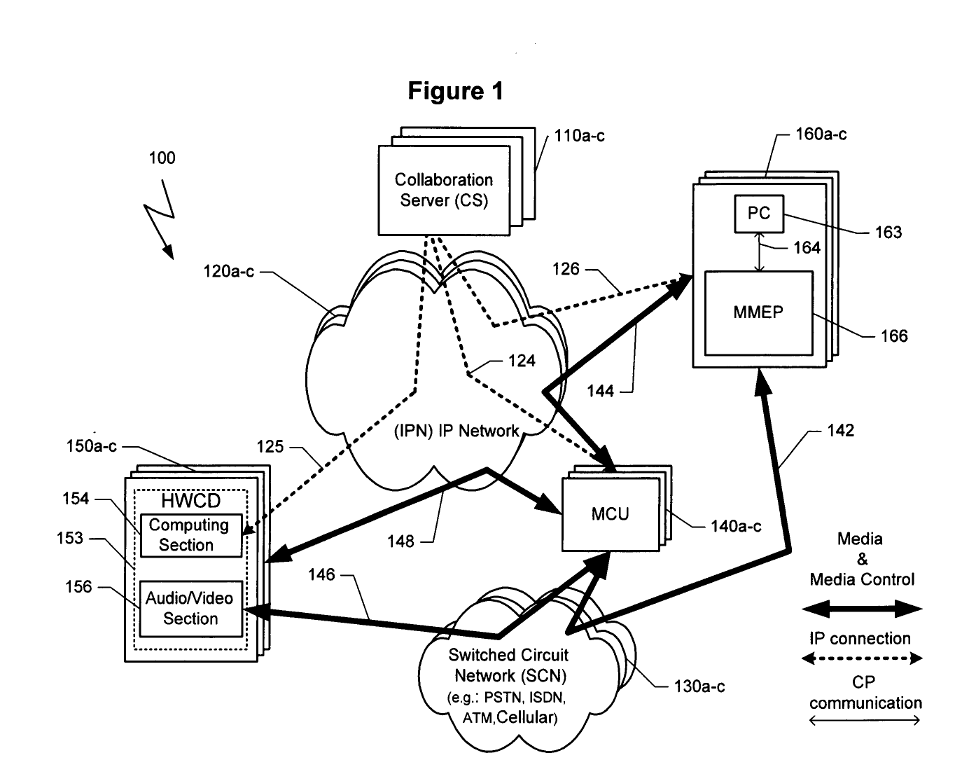

FIG. 1 is a block diagram illustrating the topology of an exemplary audio and/or multimedia conferencing system 100 that may include: one or more collaboration servers (CS) 110a-c; a plurality of users 160a-c that use multimedia endpoints 166; a plurality of users 150a-c that use handheld wireless communication devices (HWCD) 153; one or more Switched Circuit Networks (SCNs) 130a-c; one or more Internet Protocol (IP) Networks (IPNs) 120a-c; and one or more Multipoint Control Units (MCUs) 140a-c. Each user 160a-c may have a multimedia endpoint (MMEP) or a telephone (e.g. common telephone, IP phone, cellular phone) capable of communicating over a Switched Circuit Networks (SCNs) 130a-c via connection 142 or over Internet Protocol Networks (IPNs) 120a-c via connection 144. In addition, each user 160a-c may have an associated PC 163 having an IP connection 126 over an IP network (IPN) 120.

Handheld device 153 may have a computing section (data section) 154 that communicates with collaboration server 110a-c via connection 125 over IPN 120a-c. In addition, handheld device 153 may have or may be associated with audio and/or visual capabilities 156. Audio/video communication from users 150a-c may be over one or more Switched Circuit Networks 130a-c through connection 146 or through Internet Protocol Networks 120a-c via connection 148. Data and commands communication between collaboration server 110a-c and multipoint control units 140a-c, multimedia endpoint 166 and limited computing power device 153 may be accomplished via connections 124, 126 and 125 respectively over Internet Protocol Networks 120a-c. Although three units of each item are shown, there may be fewer or more than three of each item in an actual conferencing system. There is also no requirement that the number of each item be the same as the number of any other item.

Switched Circuit Networks 130a-c may be a PSTN, a ISDN, an ATM network, a cellular network or any combination thereof. Audio or multimedia endpoint/terminal 166 may provide speech only (e.g., analog telephone, cellular or IP phone), speech and data, speech and video, or speech, data and video communications or any combination thereof.

Real-time communication over Switched Circuit Networks (SCN) 130a-c may be based on International Telecommunication Union (ITU) standards such as H.320, H.321, and H.324, which are hereby incorporated by reference. SCN 130a-c may comprise gateways (not shown in the drawings) for facilitating communication between different networks. Real-time communication over Internet Protocol Networks (IPN) 120a-c may be based on ITU standards (e.g., H.323), or on Internet Engineering Task Force's Session Initiation Protocol (SIP) standard, which are incorporated herein by reference. Although not shown, IPN 120a-c may comprise gateways, gatekeepers, soft switches and other network devices. Moreover IPN 120a-c may include corporate intranet having routers, firewalls, etc. IPN 120a-c may run over physical networks such as those included in SCN 130a-c.

Each user 150a-c uses a handheld wireless communication device (HWCD) 153, such as a PDA, a cellular phone, a cellular PDA, or any other device of similar function and/or technical sophistication. Handheld device 153 may comprise a computing/data section 154 and audio or audio/video section 156. Some handheld device 153 (not shown in the drawings) may not include audio/video section 156. In such a case the user 150 may use a regular phone or cellular phone, which is not included within the handheld device 153, to participate in an audio/video session in addition to the data collaboration session conducted over the computing section 154. Computing section 154 may be connected via connection 125 over an Internet Protocol (IP) based network 120a-c, and may communicate over an Intranet with users in an organization or over the Internet with other users as well as with collaboration server 110a-c. Computing section 154 may also communicate with audio/video section 156 (if exist) over internal connection or API (application program interface). Connection 125 may be a common connection such as serial connection RS232, a wireless connection based on Bluetooth protocol, an Infra Red (IR) connection, an IP connection over a LAN or the Internet, etc. The physical connection of an IP connection 125 may run over connection 146 and SCN 130a-c toward the IP network 120a-c. Audio/video connection 146 may be a common telephone connection, a cellular phone connection, etc.

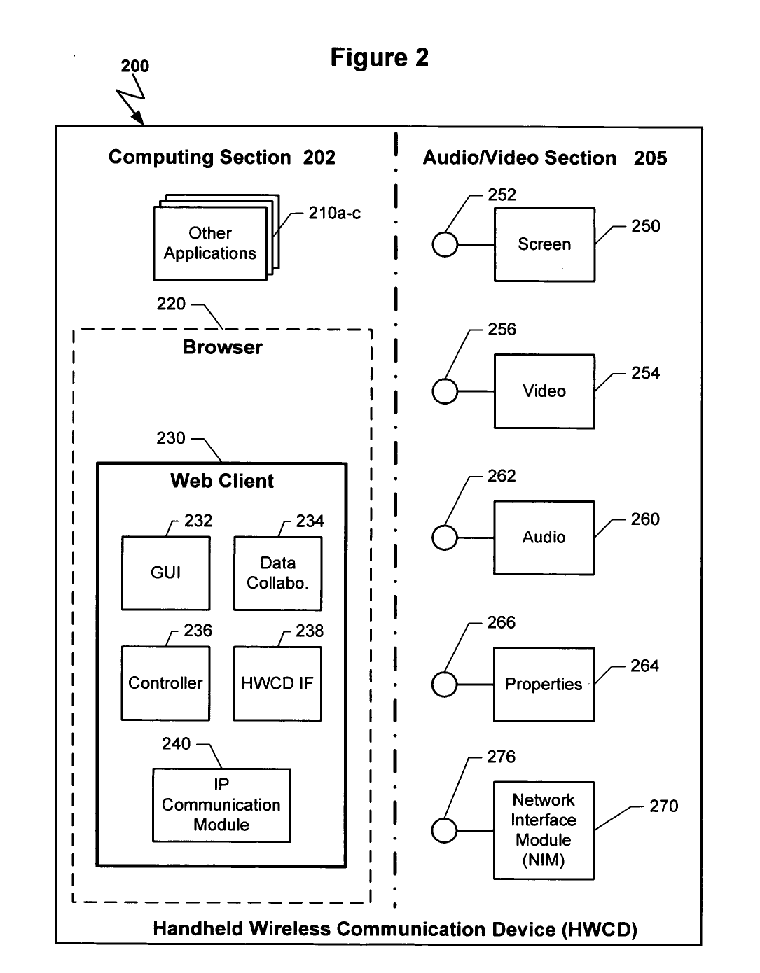

Among other tasks and applications, computing section 154 preferably runs a browser software program that can be used for communicating over IPN 120a-c with an IP server such as collaboration server 110a-c. A detailed description of computing section 154 and its operation are disclosed below with respect to FIGS. 2, 4, and 5.

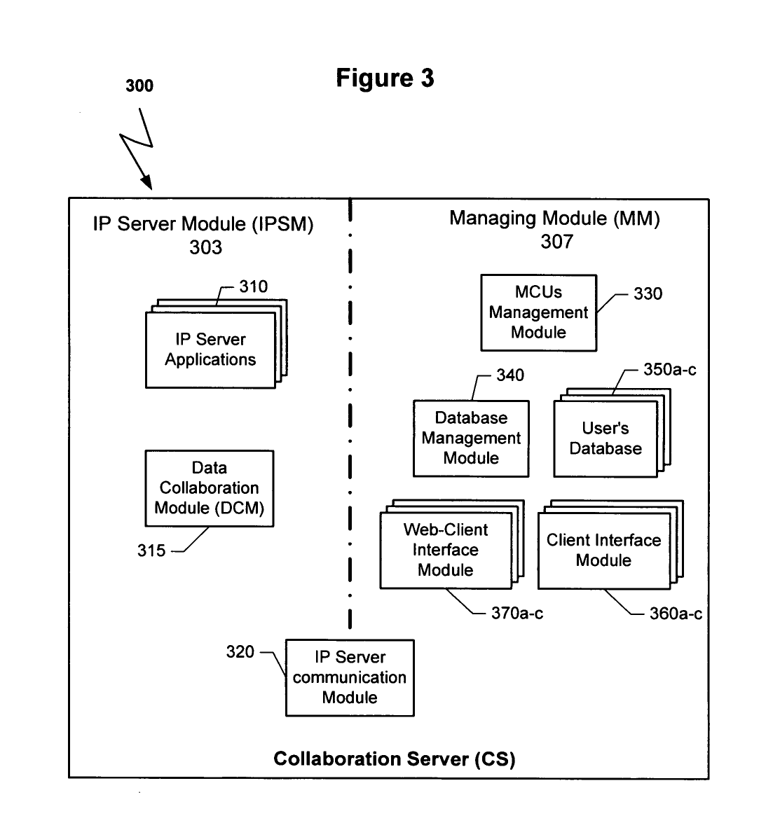

Collaboration Servers 110a-c, among other tasks and applications, may run a software program that manages one or more data collaboration sessions with or without multimedia between one or more handheld device users 150a-c and/or one or more multimedia endpoint users 160a-c. Collaboration server 10a-c may be installed, for example, in an Intranet of a corporation, or may be installed in a multimedia operator's premises close to multipoint control units 140a-c. In the latter case, collaboration server 110a-c and multipoint control units 140a-c may be connected over a LAN. Collaboration server 10a-c may also communicate with multipoint control units 140a-c via RS232 protocols, wireless protocols, etc., or the collaboration server may constitute a portion of the multipoint control units. A detailed description of collaboration server 110a-c and its operation is disclosed below with respect to FIGS. 3, 4, and 5.

Multipoint control units (MCUs) 140a-c may be common MCUs that conduct audio and/or multimedia multipoint communication. Among other ways of receiving requests to establish a multimedia session between two or more endpoints, multipoint control units 140a-c may receive a request from collaboration server 110a-c via IP connection 124 or any other type of connection generally known in the art. The request preferably carries required information to establish the session, such as dial-in number and/or IP address of appropriate endpoints 156 or 166, their connection parameters, identification information, etc. The request may be based on Internet Protocol or any other types of protocol generally known in the art, and may be processed by an appropriate Application Program Interface (API) at the multipoint control units.

FIG. 2 shows a block diagram of exemplary software modules that may be used by a handheld wireless communication device (HWCD) 200. HWCD 200 may comprise, among other modules, two main modules: a computing section 202 and an audio/video section 205. An exemplary computing section 202 may comprise one or more other applications 210a-c such as word processing, spreadsheet, email, or presentation applications, etc. In addition, computing section 202 comprises a browser application 220 such as Mobile Internet Explorer™ or Mobile OPERA™, Blazer, etc.

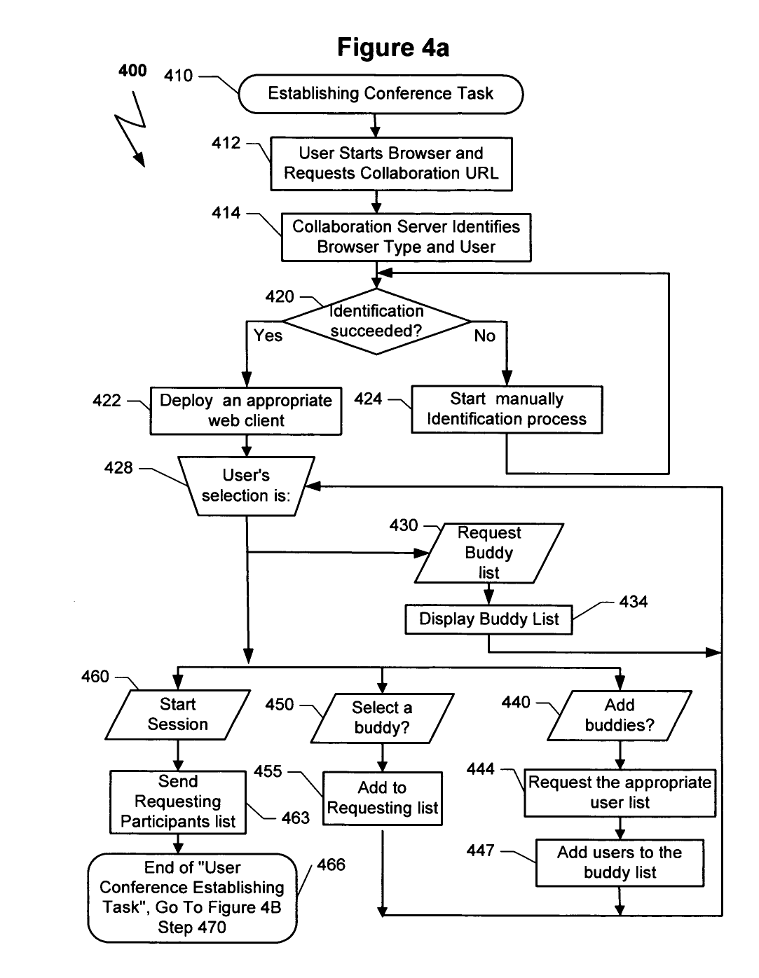

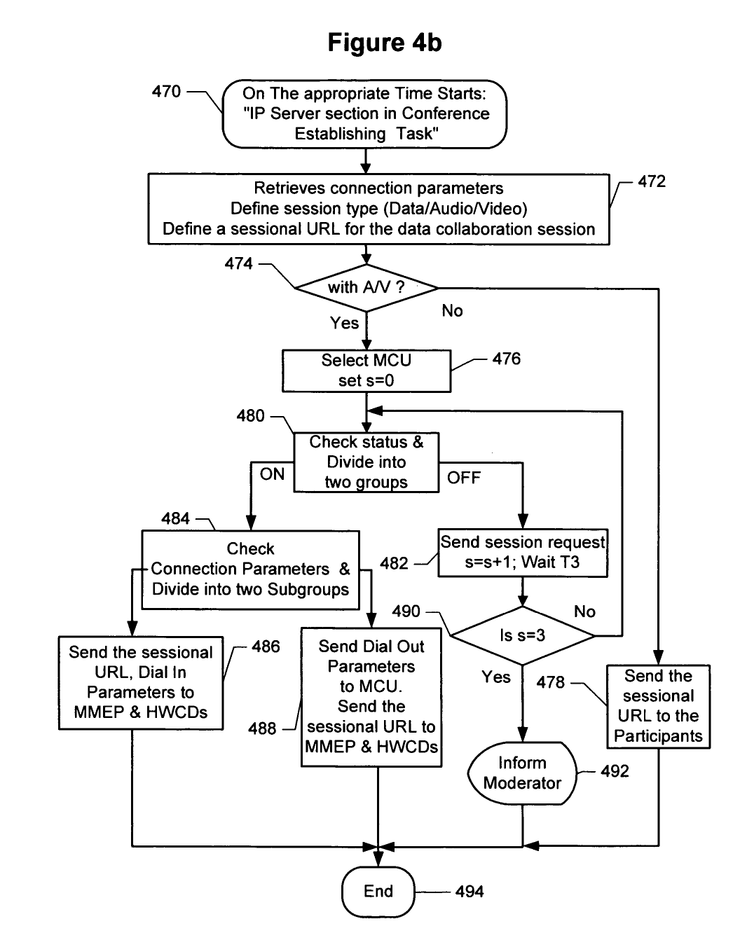

A web client 230 is deployed into browser 220 for extending the browser's capabilities to include data or multimedia conference functionality. At the end of the collaboration session when the browser is not active or is used for surfing other web sites, the web client is discarded and the resources of the handheld device that were associated with the web client 230 are released. Exemplary web client 230 may comprise a GUI module 232, data collaboration module 234, a controller module 236, HWCD interface module 238, and IP communication module 240. More information about the deployment of web client 230 into browser 220 is disclosed below in conjunction with FIG. 4. In one exemplary embodiment of the present invention, the web client 230 can be a scripting language such as, but is not limited to, Jscript, VBScript, etc. In another embodiments, the web client 230 may be implemented as a software application such as Java application, Java applet, ActiveX, etc.

GUI module 232 may offer collaboration tools to users of handheld devices 200 during the operation of an embodiment of the present invention. It may offer different user interfaces depending on the stage of the collaboration session. For example, during the set up of a collaboration session, GUI module 232 may offer the user the following options: Display Buddy List, Add Buddy to the list, Select a buddy, Start a Session, etc. Each selection may be followed by sub-menu. During the collaboration session, GUI module 232 may offer other user interface tools depending on the type of collaboration. For example, an exemplary collaboration main menu may offer the following options: Annotation, Read Only, Floor Taken (Role Delegation), Share Computer Screen, Share Document, etc. Selecting the annotation option may deliver an annotation sub-menu with exemplary tools such as a marking pen, typing, etc. Other collaboration tool may be Voting, Polling, Questions & Answers (Q&A), etc.

Data collaboration module 234 receives and handles shared data/file from collaboration server 110 (FIG. 1). The data collaboration module 234 follows user modifications on the shared data and prepares information that will be transferred to collaboration server 110. For example, during an annotation operation, data collaboration module 234 may follow the movement of the user's stylus (or cursor), calculate the exact location of the annotation, process the text that is added by the user and prepare this information to be sent to collaboration server 110. In one embodiment of the present invention, only differences from the previous changes are sent to collaboration server 110. In another embodiment, the entire file with the modifications is prepared and sent to collaboration server 110.

Handheld wireless communication device interface module 238 is the interface between the modules of web client 230 and the modules of Audio/Video section 205 of handheld device 200. For example, interface module 238 may connect GUI module 232 with audio module 260 via API 262 to perform an Interactive Voice Response (IVR) session with an user; connects data collaboration module 234 with screen module 250 via its API 252 to display a shared file; and/or transfers information between GUI module 232 and screen module 250 via its API 252 to display the different collaboration menus, etc.

Controller module 236 controls the operation of web client 230. Controller module 236 receives different information, statuses, user selections, user modifications from GUI module 232, data collaboration module 234, and interface module 238, and processes them and transfers relevant information to collaboration server 110 (FIG. 1) via IP communication module 240 through the network interface 270 and its API 276. In the other direction, controller module 236 may get data or commands from collaboration server 110, process it and create relevant instructions and/or data to be transferred to one or more modules of the web client 230. Controller module 236 may create an automatic refresh command to retrieve a refresh page from collaboration server 110. Furthermore, if web client 230 is a signed application, controller module 236 may communicate with properties module 264 via interface module 238 and API 266 to retrieve relevant properties associated with the handheld device 200. These properties include, but are not limited to, cellular number, IP address, HWCD serial number, operating system, etc.

IP communication module 240 is the interface between controller 236 and collaboration server 110. It receives data or commands such as user selections, automatic refresh, etc., to be sent to collaboration server 110. The data can be information that the user would like to share with others or shared data with the user's modifications. IP communication module 240 may process the information according to the IP protocol, divide the data into packets, add headers etc., and transfer the packets to network interface module 270 via API 276 to be sent over the physical network according to communication protocol of the physical network.

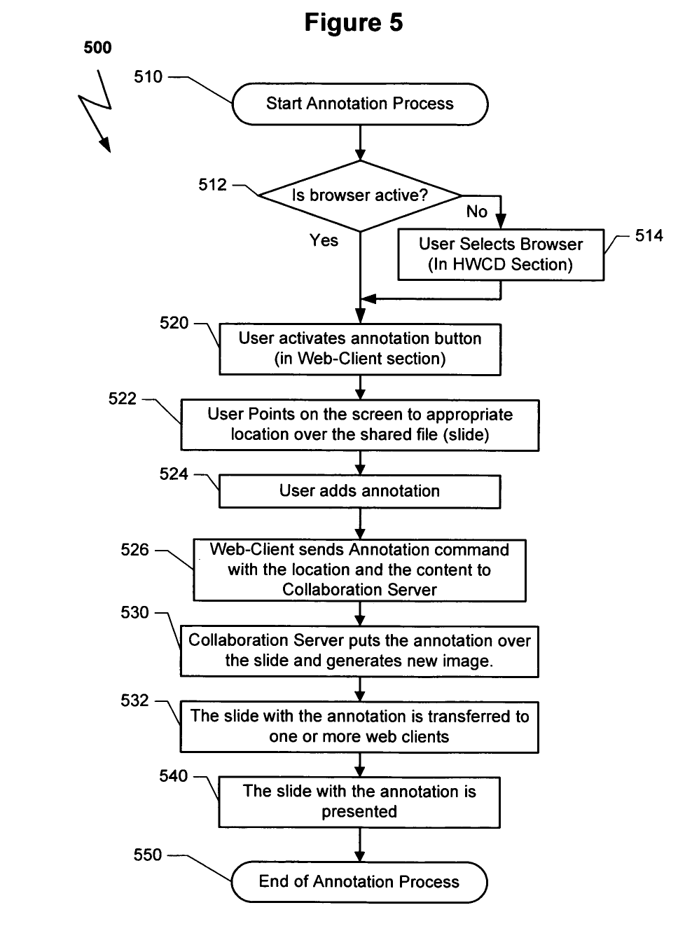

In the other direction, data from collaboration server 110 is transferred via the physical network, network interface module 270 and API 276 to IP communication module 240. IP communication module 240 processes the packets, removes IP network overhead, and transfers the data to controller 236 to be processed and distributed to relevant modules of web client 230. In an alternate embodiment, IP communication module 240 may distribute the received data directly to the appropriate module and not via controller 236. For example, received shared data may be transferred directly to the data collaboration module 234. More information on the operation of web client 230 is disclosed below in conjunction with FIGS. 4 and 5.

The audio/video section 205 of handheld device 200 may comprise some or all of the following modules and associated APIs: screen module 250, video module 254, audio module 260, properties module 264, and network interface module 270. Screen module 250 is the module that controls the display of handheld device 200. It may communicate, via API 252, with some of the other applications 210a-c, browser 220, or video module 254 (if it exists). In some models of handheld device 200, screen module 250 may also be used to receive inputs from users (e.g., touch screens). Screen module 250 may display video images that are received via video module 254, or may display data that is generated by one of the applications 210a-c or by the browser 220. The display may be divided into two sections or may be time-shared between the video and data.

Video module 254, if it exists, communicates with a user and/or one appropriate applications from the group of applications 210a-c via API 256. Based on user instructions, video module 254 may control a video camera, receives video images from the camera, encode a video stream and process it according to appropriate video communication protocols. The processed video stream is then sent via network interface module 270 to its destination, for example, to one of the multipoint control units 140a-c (FIG. 1). In the other direction, a video stream is received via network interface module 270 which processes the received video according to network protocols to retrieve the encoded video stream. The encoded video stream is then transferred to video module 254, which decodes the encoded steam and transfers the decoded video data to screen module 250 via APIs 256 and 252 to be displayed.

Audio module 260, if it exists, communicates with a user and/or one appropriate applications from the group of applications 210a-c via API 262. Based on user instructions, audio module 260 may receive audio from a microphone (not shown), encode an audio stream and process it according to appropriate audio communication protocols. Then the processed audio stream is sent via network interface module 270 and APIs 262 and 276 to its destination, for example, to one of the multipoint control units 140a-c (FIG. 1). In the other direction, an audio stream is received via network interface module 270 which processes the received audio according to network protocols to retrieve the encoded audio stream. The encoded audio stream is then transferred to audio module 260 which decodes the encoded steam and transfers the decoded audio data to a speaker (not shown).

Properties module 264 may include information on the properties of handheld device 200. Such information includes, but is not limited to, a handheld device's ID number, cellular number, type of operating system, memory size, screen resolution and size, etc. Properties module 264 may communicate with other software modules via API 266. In general, communication with API 266 is restricted to the internal modules of handheld device 200. If an external application deployed to handheld device 200 needs to communicate with properties module 264, such application has to be a signed application or authorized application.

Network interface module 270 is the module that receives, via API 276, compressed audio with or without video from the audio and video modules (260, 254) as well as data from the computing section 202, processes and prepares the information according to the communication protocol that is used by the network, and sends the processed information over a physical network. In the other direction, network interface module 270 receives information from the physical network, processes it according to the communication protocol and distributes the processed information to the appropriate module. The physical network can be cellular, Bluetooth, wireless, infrared, LAN, etc.

An exemplary embodiment of collaboration server 300 is shown in FIG. 3. Collaboration server 300 may comprise two main modules: an IP server module (IPSM) 303 and a managing module 307. The IPSM 303 preferably comprises different IP server applications 310, a data collaboration module 315, and IP server communication modules 320. Exemplary managing module 307 may comprise a multipoint control unit management module (MCUM) 330; a database management module (DBMM) 340; one or more user databases (UDB) 350a-c; one or more client interface modules (CIM) 360a-c, one for each user 160a-c who has a multimedia endpoint 166a-c (FIG. 1); and one or more web-client interface modules (WCIM) 370a-c, one for each user 150a-c having a handheld device 153a-c (FIG. 1).

In one embodiment of the present invention, collaboration server 300 may reside at the premises of a multimedia service provider. Alternatively, the server may be located in a multipoint control unit and be dedicated solely for multimedia conferences. Data collaboration module 315 may contain data collaboration applications such as Polycom WebOffice™, WEBEX™, etc. More information on Polycom WebOffice™ is disclosed in U.S. patent application Ser. No. 10/941,790, the content of which is incorporated herein by reference.

IP Communication Module 320 communicates between the internal modules of collaboration server 300 and different destinations over one or more IP networks 120a-c (FIG. 1). Exemplary destinations include a plurality of handheld devices 153 (FIG. 1), a plurality of PCs 163 (FIG. 1), one or more multipoint control units 140a-c (FIG. 1), etc. IP communication module 320 maintains the connections, processes the received IP packets, removes IP network overhead and transfers the data to an appropriate module such as IP server applications 310, web-client interface modules (WCIM) 370a-c, or client interface modules (CIM) 360a-c. In the other direction, data received from IP server applications 310, WCIM 370a-c or CIM 360a-c are divided into packets according to the protocol with appropriate headers and are sent to an appropriate destination such as handheld device 153 or PC 163.

The multipoint control unit management module (MCUM) 330 of the managing module 307 may manage a database of connection parameters and available resources for one or more multipoint control units 140a-c associated with a collaboration server 110 (FIG. 1). The connection parameters include, but are not limited to, the type of supported networks (ISDN, PSTN, IP etc.), bit rates, IP addresses or dialing number, and communication standards (H.320, H.324, SIP, H.323, etc.) of each one of the multipoint control units, etc.

MCUM 330 receives a list of users with a request to connect them to a multimedia session. The list may be sent from a moderator who requests the multimedia session. The request can be created and sent by a web client 230 running in the moderator's handheld device 153 via an appropriate web-client interface module 370a-c. Upon receiving the request, MCUM 330 may request database management module 340 to retrieve information of those users from an appropriate user's database 350a-c. MCUM 330 may then decide whether the request is for a point-to-point session, a gateway session, or a multipoint session based on the connection parameters of the users and the number of users in the list.

If it is determined that the session is a multipoint session, then MCUM 330 would select an appropriate multipoint control unit (MCU) 140a-c and sends the parameters of the conference to that MCU. These parameters include the list of users that the MCU has to call (dial-out) and their connection parameters. Some of the dial-out numbers can be cellular telephone numbers of the handheld devices 153 that belongs to one or more users on the list. On the other hand, MCUM 330 may transfer the parameters of selected MCU 140a-c to an appropriate web-client interface module 370a-c when a user's handheld device 153 has to dial to the MCU (dial-in) to join the conference. In one embodiment of the present invention, the appropriate web-client interface modules 370a-c may send the dial-in information as an SMS or as an instant message. In another embodiment, the dial-in parameter of the selected MCU may be added to the URL of a data collaboration session associated with the multimedia session.

If the session is a point-to-point session or a gateway session, MCUM 330 would send (via an appropriate web client interface module 370a-c) to the moderator's handheld device the connection parameters of the other user or gateway being contacted. The MCUM 330 then preferably requests the handheld device of the moderator to call the endpoint of the other user or the gateway. The connection parameters of the other user or gateway may be sent in the same way as that described above with regard to sending the dial-in parameters of multipoint control unit.

User's databases 350a-c preferably comprises databases containing information about the users whom may be served by collaboration server 110. For example, user's databases 350a-c may be divided into groups, each of which may be associated with a particular corporation. Each group may be further subdivided into corporate subgroups, etc., and/or the user's database 350a-c may contain private sections for individual users. Access to each group, subgroup or private section may be limited to authorized users. Each entry in user's database 350a-c preferably contains, among other parameters, the name of a buddy, the type of the buddy's endpoint, current endpoint status, and connection parameters of those endpoints, etc. The connection parameters may include ‘dial in’ number and/or IP address for the endpoints, minimal connectivity speed, maximal connectivity speed, type of communication standards that can be supported by the endpoint, etc. User's databases 350a-c are preferably managed by database management module 340, and may import information from other databases and or applications, e.g. from a Microsoft Exchange™ application.

Database management module 340 may request from time to time an update on the status of the users' endpoint 153. Such request may be sent via web-client interface module 370a-c to the appropriate web client 230. Upon receiving their responses, database management module 340 may update their entries in a user's database 350a-c. Alternatively, database management module 340 may be passive and waits until receiving a status update from a user to update the entry of that user in the user's database 350a-c.

Database management module 340 may receive a request from a user, via web-client interface module 370a-c, to send a list of users' names from a certain group, sub-group or private section of user's database 350a-c. After verifying authorization of the request, database management module 340 may send the requested list via the same web-client interface module 370a-c to the appropriate web client 230. Database management module 340 may also receive requests from multipoint control unit management module 330 to provide connection information for certain sets of users, to which the database management module 340 responds by retrieving the appropriate information from user's database 350a-c.

In one embodiment of the present invention, the collaboration server 300 may have a bank of web-client interface modules 370a-c, each of which is associated with a user having a handheld device 153. Each web-client interface module 370a-c has an associated address (URL) to which the handheld device needs to be connected, via the handheld device's browser, to start or join a collaboration session. Henceforth, the description of the present invention may use the term ‘URL’ as a representative term for any type of an address that can be use in communication over an IP network. Each web-client interface module 370a-c may comprise a web client 230 that is adapted to the operating system and the browser installed in the associated handheld device. Upon establishing a connection with the associated user, the web client 230, which is adapted to the properties of the handheld device, is deployed to the browser 220 of the handheld device for extending the browser's capabilities to include data or multimedia conference functionality. The web client 230 (FIG. 2) may communicate with different modules of the collaboration server 300 via the web-client interface modules 370a-c as disclosed above. In one exemplary embodiment of the present invention, the web client 230 can be implemented by a scripting language such as Jscript, VBScript, etc. In other embodiments, the web client 230 may be implemented as a software application such as Java application, Java applet, ActiveX, etc.

Web-client interface module 370a-c may perform functions associated with data collaboration. The interface module 370a-c may communicate with data collaboration module 234 of web client 230; acquire user modifications on the shared file; adapt the modification to the requirements of data collaboration module 315; and transfer the adapted file to data collaboration module 315 for collaboration with other users. In the other direction, web-client interface module 370a-c may retrieve shared data from data collaboration module 315; process the data to facilitate display over the screen of the associated handheld device; and send the data to web client 230 (FIG. 2). In another embodiment, before sending the processed data, web-client interface module 370a-c may compare currently processed data with previous data and send only the differences from the previously processed data. The currently processed data may be stored instead of the previously processed data. Sending the information to the web-client can be preformed upon receiving a refresh request from the web-client. More information concerning the operation of collaboration server 300 is disclosed below in conjunction with FIGS. 4 and 5.

FIGS. 4a and 4b illustrate a flowchart showing the relevant steps in an exemplary method 400 for establishing a multimedia session using a handheld wireless communication device 153. Method 400 starts when a user who wishes to initiate the session (i.e., the moderator) selects 412 a browser application and requests a collaboration URL. In one embodiment, the collaboration URL may be a private URL that is associated with a particular user. Alternatively, the collaboration URL may serve more than one user. For example, a collaboration URL may be associated with an organization and people in that organization may use the same collaboration URL.

Upon receiving a request to retrieve a moderator's private URL, collaboration server 110 may invoke a web-client interface module 370 that is associated with the private URL. The web-client interface module then starts an identification process 414 that can be based on the source IP address of the request, the cellular number, type of browser, etc., and compares these parameters with those stored in the web-client interface module. If the identification process is successful at step 420, an appropriate web client 230 is sent and deployed into the browser 220 of the moderator's handheld device and a collaboration page is shown to the moderator. The collaboration page may appear as a web page that includes collaboration tools such as one or more user's selection buttons, and dial in number of a multipoint control unit that is assigned to conduct an A/V session associated with the data collaboration session, etc.

If the identification process is not successful, then the web-client interface module 370 may start a manual identification process 424 and send an identification page to be displayed over the screen of the handheld device 153. The identification page may request the moderator to enter personal information such as user name, password, IP address, cellular number, operating system, browser, etc. Upon receiving the response from the user, the web-client interface module 370 may search the user's database 350 for a matched entry. If an entry is found, then the validity of the password is checked and the user's database may be updated with new personal information. After successful identification, method 400 then proceeds to step 422. If the user's name is not found or the password is not correct, then method 400 may repeat steps 420 and 424 a few times, e.g. three or four times, to allow the user to correct his mistake. If the identification process fails in those trials, the request is denied and the user may be requested to call a help desk.

In another embodiment, a collaboration URL may serve a plurality of users. Upon receiving a request to retrieve a collaboration URL, collaboration server 110 may invoke a similar identification process 414 as described above. The identification process may be based on parameters such as the source IP address of the request, the cellular number, etc. Then the user's database 350 is searched for an entry having one or more of these parameters. If the identification process is not successfully terminated, then a manual identification process 424 may be started as it is disclosed above. If an entry is found and the identification process is successful, collaboration server 110 may create a temporary web-client interface module comprising a web-client that fits the requirement of the user's handheld device and a temporary private URL assigned to the temporary web-client interface module. The temporary web-client interface module may acquire the communication parameters of the user's device from user's database 350. Alternatively, the temporary web-client interface module may acquire a link to the user's communication parameters in the database. Eventually, a web client 230 is sent and deployed into the browser of the user's handheld device.

In both cases of using a temporary web-client interface module or a private web-client interface module, the web client 230 may include a visible section and an invisible section. The visible section may include a collaboration page that is displayed to the moderator. This collaboration page may appear as a web page that includes collaboration tools as described above. The invisible section may include different software modules described above in FIG. 2, for example, GUI 232, Data Collaboration module 234, IP communication module 240, etc. The IP communication module may include the assigned URL of the appropriate web-client interface module.

At step 428, method 400 waits for a user's selection. A few non-limiting examples of user selections on a collaboration page are described below. The selection operation can be similar to using selecting buttons over a common web page. For example, a user who wishes to establish a multimedia session (e.g., the moderator) may select 430 the option to display a user's buddy list. The request may be sent by the web client to the assigned web-client interface module 370 (FIG. 3), which in turn requests the user's buddy list via the database management module 340 and user's database 350. The retrieved buddy list is then transferred to the assigned web-client interface module, which may embed the list in a HTML page and sends it as a response to the user's selection. Upon receiving the buddy list, web client 230 at step 434 may display the buddy list to the user, and method 400 returns to step 428 for another selection.

Then, the moderator may select 450 a buddy from the list, and add 455 the buddy to a requesting list, which includes users that are requested by the moderator to be participants of the session. If the instruction 440 is a request to add users to the moderator's buddy list, then web client 230 may transfer the request 444 to an appropriate web-client interface module in collaboration server 110, and request an appropriate user list from the user's database 350a-c. The appropriate user list may be defined by the moderator or may be automatically selected depending on the moderator's characteristic. The requested user list is thereafter transferred to and displayed in the moderator's handheld device. The moderator may then select and add 447 one or more users to his buddy list. Alternatively, the web-client interface module may send to the moderator an “Add Buddy Page” that includes fields for the name of the user, his multimedia endpoint address, cellular number, etc. Upon entering in the information, the Add Buddy Page is sent to the web-client interface module to be processed and added to the user's buddy list.

If the instruction 460 is to establish or start a conferencing session with users previously selected on a requesting list, then the requesting list is sent 463 to the collaboration server 110a-c via IP connection 125 (FIG. 1). Henceforth, control over the establishment of the multimedia session is transferred 466 to the collaboration server 110a-c and the web client resources at the moderator's handheld device may be released.

Upon receiving the requesting list and the request to establish a multimedia session, a decision is made whether the session is an ad-hoc session that has to be started now, or reserved for a later time. If the request is for a later time, the request may be stored in a database and an indication (reference) may be placed in a scheduling application with appropriate date and hour. An invitation may also be sent to the users informing them about the session. The invitation may be sent via email, SMS, instant message, etc. If the request is for an ad-hoc call, then collaboration server 110a-c may start a multimedia conference establishment task as discussed below with respect to FIG. 4b.

Upon receiving 470 the requesting list along with the request to establish a multimedia session, managing module 307 (FIG. 3) at an appropriate collaboration server 110 begins the process of establishing a multimedia session. In case of an ad-hoc call, the request may be received directly from a handheld device 153. In case of a reserved call, the request may be retrieved from the database at an appropriate time by a scheduling application and transferred to managing module 307. Subsequently, at step 472, managing module 307 may retrieve from an appropriate user's database 350a-c the connection parameters for each one of the users included in the requesting list. In addition, the type of multimedia session is analyzed and decisions are made with regard to a number of issues such as whether the session is a data collaboration session only, an audio session with or without data collaboration, an audio/video/data session, point-to-point or multipoint in nature, whether layouts are required in a video session, and whether transcoding is required due to different communication protocols or compression schemes used at the endpoints, etc.

Furthermore, a sessional URL may be assigned for the data collaboration session. The sessional URL can be a private sessional URL that is associated with a moderator. Alternatively, one of a plurality of sessional URLs is assigned to a session so long as the collaboration session is active, and at the end of the session the sessional URL is returned to a pool of URLs from which a sessional URL may be assigned for another data collaboration session. The assigned sessional URL, information on the data collaboration session, and the users that participate in the session are then transferred to data collaboration module 315. In one embodiments of the present invention, the sessional URL may be the same as the collaboration URL described above. In other embodiments, the sessional URL and the collaboration URL may be two different URLs.

At step 474 a decision is made on whether the session includes audio or audio/video in addition to data collaboration. If the session is just a data collaboration session without audio/video signals, the sessional URL for the session as well as invitation to the session are transferred 478 to the moderator and other participants. Sending the invitation with the sessional URL may be done via an SMS, Email, instant message, etc. For example, the message may be sent as a SMS (to the user's handheld device or associated cellular phone) or as an Email to the computing section 154 via connection 125 (FIG. 1).

If the session includes audio and/or video component, then a multipoint control unit (MCU) may be selected at 476 to conduct the audio/video conference. Selecting a MCU from a group of MCUs 140a-c (FIG. 1) may be based on availability of resources, cost of communication, etc. More than one MCU may be selected to handle a session, in which case the selected MCUs may operate in a cascading fashion. In case there are no free resources to carry the session, a message is preferably sent to the moderator informing him that the request for a multimedia session is denied. A counter ‘s,’ which counts the number of trials that will be attempted to inform an unavailable user before a message is sent, is reset at 476 concurrent with MCU selection.

After a MCU is selected, the connection parameters and the status of each buddy on the requesting list are analyzed at 480 to determine the type of media that can be used and the availability of the user. Managing module 307 (FIG. 3) may divide the users on the requesting list into groups, such as but not limited to: a group of users whose devices are “off” and/or are away or unavailable; and a group of users whose endpoints are “on” and are available.

Each of the above groups may be handled by separate tasks executed in parallel. The “off” group task starts at step 482 in which a message is sent to users to inform them of their “off” status and the fact that they are being requested to join a conference. Such a message may be sent in a similar way as that disclosed above in step 478. An exemplary message may inform the user that the moderator invites him to a session and requests the user to be available. Thereafter, the counter ‘s’ is increased by one and the task may wait for a period T3 (e.g. a few minutes or so) at 482. After time period T3, a decision is made at 490 to see whether ‘s’ has reached a certain number (e.g. s=3). If ‘s’ has not reached that particular number, method 400 returns to step 480. During this cycle only users who were “off” in the previous cycle are handled. When 490 ‘s’ reaches a certain number (3 in this example), a message is sent at 492 to inform the moderator that one or more users are unavailable and cannot be connected to the session. Then the task is terminated at 494. If the moderator's device is a handheld wireless communication device, then the message may be sent via web-client interface module 370 to web client 230 in the moderator's handheld device.

The group of users whose devices are “on” is handled by a task that starts at step 484 in which the connection parameters of the device of each member of the “on” group is checked to divide the group into two subgroups: a “dial out” group and a “dial in” group. As mentioned earlier, a “dial out” user can be a user whose device cannot be externally instructed to initiate a call, for example, a regular telephone, a cellular phone, etc. Accordingly, a multipoint control unit must bear the burden of contacting such users. In contrast, a “dial in” user can be a user whose endpoint has the capability to be externally controlled to initiate a call via a web client or agent depending on the type of the endpoint. Examples of such endpoints include, but are not limited to, Polycom ViewStation™, or a handheld device such as HP iPAQ™.

The list of the “dial out” subgroup is sent 488 to the selected multipoint control unit which is instructed to call those users and to add them to the session. At the same time, sessional URL for the data collaboration may be sent in an SMS, Email, instant message, etc. If the user has a handheld device 153 (FIG. 1), the message with the sessional URL may be sent as a SMS or as an email to the computing section 154 via connection 125 (FIG. 1). The dial-in group is handled at step 486. Each one of the handheld device users 150a-c who belongs to a dial-in group may get a sessional URL for the session and the dial-in number in a message such as SMS, instant message, etc.

When the start time of a collaboration session has arrived, a user of a handheld device 153 may set up a connection with collaboration server 110 using the browser 220 and the sessional URL that was sent to him during one of the steps of 478, 486 or 488. The collaboration server may in response start a collaboration session with the user using a process similar to the one disclosed above in steps 412 to 422 in FIG. 4a. At the end of the process a web-client interface module is assigned to the user and a web client is deployed into his browser. In one embodiment of the present invention, the web-client interface module (WCIM) 370 (FIG. 3) may be a temporary one having a temporary private URL. In another embodiment, the WCIM 370 may be a private WCIM that has been permanently assigned to the user. The permanent WCIM may have a permanent private URL that may be the same as the private collaboration URL. The visible section of the deployed web client 230 may include a welcome page to be displayed on the screen. The welcome page may include information such as a header of the session, names of participants, dial-in number for the audio/video connection, etc. The invisible section of the web client may include the temporary or permanent private URL that will be used for the collaboration session. The dial-in number of the audio/video session may also be embedded in the invisible section.

The web client may inform the user to call the dial-in number to join the audio or audio/video session. Alternatively, the web client may instruct the audio/video section 205 (FIG. 2) of a handheld device to automatically set a connection with the assigned multipoint control unit, or another endpoint in case of a point to point call. When the connection is established, the web client may inform the user. Connection with the multipoint control unit may be done via network interface module 270 (FIG. 2), audio module 260 (FIG. 2), and video module 254 (FIG. 2). After sending the dialing information and the sessional URL, the conference establishment task is terminated at 494.

The collaboration welcome page may include several user selection buttons. Exemplary selection buttons include, but are not limited to, Displaying Shared File, Annotation, Floor Request, Role Delegation, etc. The user's selection may be handled in a similar way as disclosed above in conjunction with steps 428 to 466. For example, if the user selects at 428 an annotation process, then process 500 which is illustrated in FIG. 5 may be initiated.

FIG. 5 illustrates a flowchart of an exemplary annotation process 500 that may be used by a user of a handheld wireless communication device (HWCD) to add annotations or changes to a shared document. The annotation process 500 is disclosed as an exemplary embodiment of a collaboration task. There is no intention to limit the scope of the invention to annotation process only. Process 500 covers tasks preformed by the user, the user's HWCD, and the collaboration server. To start 510 the annotation task 500, the browser has to be active and displayed on the screen of the HWCD. If the browser is not active, for example, the video of the conference is displayed over the screen of the HWCD, then the user selects 514 the browser button. In response, the screen module 250 may display over the screen data coming from the browser instead of the video of the conference. Since the collaboration session has been established earlier, the data collaboration page is displayed upon browser selection and the method 500 may wait until the user selects the annotation button at step 520.

Upon selecting the annotation button at step 520, the annotation command is transferred from GUI module 232 (FIG. 2) to controller module 236 (FIG. 2), which in turn instructs data collaboration module 234 (FIG. 2) and GUI 232 to start the annotation process. Upon initiating the annotation process in the handheld device, a layer above the shared file may be displayed with a cursor and a note requesting the user to select (e.g., point to) the location of the annotation. Method 500 may discover the location of the cursor while the user presses the enter command or tapping the stylus. Upon receiving the enter command, the web client may save the location of the annotation. A space may be opened above the annotation location for the user to type in any modification. Method 500 may display the typing over the screen of the user's device. Upon receiving the enter command, the text and the location of the annotation are processed by data collaboration module 234 in the web client 230 and transferred to collaboration server 110 (FIG. 1) with a command to add the annotation over the shared file and display the file to other conference participants.

The information may be transferred to collaboration server 110 via IP communication module 240 (FIG. 2) using the private collaboration URL of the private web-client interface module or the temporary private URL of the temporary private web-client interface module. The communication may be based on IP such as TCP/IP, or use a tunnel established between the IP communication module 240 and an appropriate web-client interface module 370 (FIG. 3).

An appropriate web-client interface module 370 may receive at 530 the annotation command with the annotation location and text. The received location adapted to the screen of the handheld device is converted to appropriate location within the shared file. The correct location and text are transferred to data collaboration module 315 which may create at 530 a new shared file that includes the annotative text in appropriate location. The new shared file is stored instead of the old one in the URL of the collaboration page. An indication of the new shared file may be transferred to different web-client interface modules that participate in the session.

In one embodiment of the present invention, upon receiving the indication on the new shared file, each web-client interface module may retrieve the new shared file, adapt it to the associated handheld device, and push at 532 the adapted new shared file through a tunnel established between the web-client interface module and an appropriate IP communication module 240 (FIG. 2).

In another embodiment, the web-client interface modules may wait for a refresh command from their associated web clients. Upon receiving the refresh command, the relevant web-client interface modules retrieve the new shared file, adapt it to the requirements of their associated handheld devices, and send it at 532 to their web clients as described above. The refresh command may be generated automatically, every few seconds for example, by the controller module 236 (FIG. 2).

The received new shared file with the annotation is transferred to GUI 232 to be processed and presented at 540 over the screen of a handheld device. Presenting the file may be done via HWCD interface module 238 and screen module 250 (FIG. 2) via its API 252. Method 500 is then terminated and the user is free to start another collaboration process.

While discussed in terms of collaboration via annotation, it should be understood that such annotations can comprise changes to the file, as well as annotation comments placed with the file. This may require that the handheld wireless communication devices have API for the file program in question (e.g., word processing, spreadsheets, etc.).

In this application, the words “unit”, “element” and “module” may be used interchangeably. Anything designated as a unit or module may be a stand-alone unit or a specialized or integrated module. A unit or a module may be modular or have modular aspects allowing it to be easily removed and replaced with another similar unit or module. Each unit or module may be any one of, or any combination of, software, hardware, and/or firmware.

Those skilled in the art will appreciate that portions of the collaboration server 110a-c (FIG. 1) of the present invention and its methods can also be implemented with additional software residing in the multipoint control unit (MCU) or in a multimedia endpoint, with additional hardware added to the MCU or to a multimedia endpoint, or with additional software or hardware distributed among the MCUs.

It will be appreciated that the above described methods may be varied in many aspects, including but is not limited to, changing the order of steps, and the exact implementation used. It should also be appreciated that the above described description of methods and apparatus are to be interpreted as including apparatuses for carrying out the methods and methods of using the apparatus.

The described embodiments comprise different features, not all of which are required in all embodiments of the invention. Some embodiments of the present invention utilize only some of the features or possible combinations of the features. Different combinations of features noted in the described embodiments will occur to persons skilled in the art. The scope of the invention is limited only by the following claims.

What is claimed is:

1. A method for establishing a collaboration session using a handheld wireless communication device, the method comprising:
activating a browser application at the handheld wireless communication device;
wirelessly retrieving a collaboration URL from a collaboration server;
wirelessly deploying a web client into the browser, wherein said web client is associated with the retrieved collaboration URL; and
wirelessly sending a request to the collaboration server to establish the collaboration session.

2. The method of claim 1, further comprising defining one or more participants for the collaboration session.

3. The method of claim 1, wherein deploying the web client into the browser extends the browser's capabilities to include information collaboration capabilities.

4. The method of claim 1, wherein the web client is implemented by using a scripting language.

5. The method of claim 1, wherein the web client is implemented by using a Java applet.

6. The method of claim 1, wherein the web client is implemented by using a Java application.

7. The method of claim 1, wherein the web client is implemented by using an ActiveX control.

8. The method of claim 4, wherein the scripting language is Jscript.

9. The method of claim 1, wherein the web client is associated with a collaboration page comprising functional buttons to be used for defining and requesting a collaboration session.

10. The method of claim 1, wherein the web client is discarded at the end of the collaboration session.

11. The method of claim 1, wherein the collaboration session is established over an Internet Protocol network.

12. The method of claim 2, wherein the participants in the collaboration session are using multimedia endpoints or handheld wireless communication devices.

13. The method of claim 12, wherein the collaboration session comprises a multimedia session using the handheld wireless communication device.

14. The method of claim 1, wherein the handheld wireless communication device is a personal data assistant or a cellular telephone.

15. The method of claim 1, wherein the collaboration session allows the participants to work on a shared data file.

16. A method for joining a collaboration session using a handheld wireless communication device, the method comprising:
wirelessly receiving an invitation for the data collaboration session at the handheld wireless communication device, wherein the invitation comprises a sessional URL associated with the data collaboration session;
activating a browser application at the handheld device;
wirelessly retrieving the sessional URL from a collaboration server;
wirelessly deploying a web client into the browser; and joining the collaboration session.

17. The method of claim 16, wherein the web client is implemented by using a scripting language.

18. The method of claim 16, wherein the web client is implemented by using a Java application.

19. The method of claim 16, wherein the web client is implemented by using an ActiveX control.

20. The method of claim 17, wherein the scripting language is Jscript.

21. The method of claim 16, wherein the web client is discarded at the end of the collaboration session.

22. The method of claim 16, wherein the collaboration session is established over an Internet Protocol network.

23. The method of claim 16, wherein participants in the collaboration session are using multimedia endpoints or handheld wireless communication devices.

24. The method of claim 23, wherein the collaboration session comprises a multimedia session using the handheld wireless communication device.

25. The method of claim 16, wherein the handheld wireless communication device is a personal data assistant or a cellular telephone.

26. The method of claim 16, wherein the collaboration session allows the participants to work on a shared data file.
